(19) United States
(12) Patent Application Publication
(10) Pub. No.: US 2006/0237141 A1
(43) Pub. Date: Oct. 26, 2006

(54) Laminating roller and laminator therefor

(76) Inventor: Jun Cheng, Shenzhen (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/394,652

(22) Filed: Mar. 31, 2006

(30) Foreign Application Priority Data
Apr. 1, 2005 (CN) 200520033802.9

(51) Int. Cl. B32B 37/00; B30B 15/34

(52) U.S. Cl. 156/583.1; 156/555; 156/538

(57) ABSTRACT

A lamination roller comprises a rolling support (5), and a pair of connecting members (6). The rolling support is in tubular shape, and covered by a heat resistant layer (4). The pair of connecting members is respectively attached to end portions of the rolling support. The connecting member is driven by a transmission mechanism. The lamination roller and laminator therefor of the present invention with improved configurations have low power consumption and low cost characteristics, meanwhile allowing the roller and laminator maintaining laminating qualities unchanged.

### BACKGROUND OF THE INVENTION

1. Field of the Invention

The present invention is generally related to an improved laminating machine, and more particularly, the present invention relates to a light roller for laminating with improved configurations and a laminator adopting the laminating roller thereof.

2. Description of the Related Art

Laminators are used to prevent important documents from damage caused by natural or man-made factors. Because, the important documents such as papers and letters, valuable documentary papers or vouchers etc, are almost paper products and thus are liable to be ruined after repeated utilization and damage of vapor and smuts, etc. in the environment. Moreover, memorable photographs are frequently touched or repeatedly taken out from photo albums, and thus the quality of the photo pictures suffers deterioration. A general method for protecting/maintaining these documents is to sandwich the paper documents respectively between a pair of plastic film and laminate the layers of plastic film onto the paper documents with the employment of a laminating machine. The layer of laminating plastic film, usually made of a transparent plastic material, not only provides protection for these paper products from water and dirt, but also avoids wear and tear in use so that the photographs, certificates and so on can be properly preserved.

Apparatus for applying two-sided laminate sheets to the surface of a card substrate has heretofore been known in the art. Referring to FIG. 1, a conventional laminator is shown and described hereto. The laminator comprises a solid metal rolling shaft 1, and a heat-resistant gum covering the surface of the rolling shaft 1. The solid rolling shaft 1 comprises connecting portion 3 integrally lathed on respective end portions thereof. In this regard, the U.S. Pat. No. 6,640,866 to Kerr et al represents the prior art to the subject invention of which the applicant is aware. Kerr et al discloses a laminating apparatus comprises a first lamination roller and a second lamination roller. The first lamination roller or second lamination roller comprises a substantially solid core, a first deformable layer surrounding the substantially solid core, and a second deformable layer surrounding the first deformable layer.

The structure of the traditional roller of the laminator is simple and easily fabricated, however, the conventional solid structure of the rolling shafts increase total weight of the unwieldy rollers of the laminator, meanwhile brings about material wasting issues. Furthermore, a motor has to bear the burden of driving such heavy roller in the laminator, which results in higher power consumption. In addition, the unwieldy roller in the laminator is hard to be handled to finish the laminating process precisely. In the conventional laminator, the rolling shaft functions as a support and should have enough rigidity and heat resistance properties, and the deformable and resilient layer covering the rolling shaft functions as a nip mechanism, while the connecting portions of each rolling shaft function as a transmission medium and should more focus on wearing resistance property. The rolling shaft and the connecting portions at the end portions thereof serve different functions and should not be integrally designed which restrain performance of the conventional rollers of the laminator.

In light of the foregoing, there is a need to improve configurations of the conventional bus duct and electrical supply system using the same for buildings. The difficulties and drawbacks of previous system are overcomed by the bus duct and electrical supply system of the present invention.

### SUMMARY OF THE INVENTION

The systems and methods of the invention have several features, no single one of which is solely responsible for its desirable attributes. Without limiting the scope of the invention as expressed by the claims which follow, its more prominent features will now be discussed briefly. After considering this discussion, and particularly after reading the section entitled “Detailed Description of Certain Embodiments” one will understand how the features of the system and methods provide several advantages over traditional laminating rollers and laminators.

Accordingly, it is an object of the present invention to provide a light roller for laminating with improved configurations and a laminator adopting the laminating roller thereof.

Another object of the present invention is to provide a roller for laminating and a laminator with low power consumption and low cost characteristics, meanwhile allowing the roller and laminator maintaining laminating qualities unchanged.

Further objects and features of the invention will be readily apparent to those skilled in the art from the following specification which includes the appended claims and drawings.

To achieve the above objects and in accordance with the purpose of the invention, as embodied and broadly described herein, a lamination roller comprises a rolling support, and a pair of connecting members. The rolling support is in tubular shape, and covered by a heat resistant layer. The pair of connecting members is respectively attached to end portions of the rolling support. The connecting member is driven by a transmission mechanism. The lamination roller and laminator therefor of the present invention with improved configurations have low power consumption and low cost characteristics, meanwhile allowing the roller and laminator maintaining laminating qualities unchanged. One portion of the connecting member joining the rolling support is cylindrical, the diameter of the cylindrical portion of the connecting member is slightly longer than inner diameter of the tubular rolling support, thereby the connecting member can be fitted into the tubular rolling support in an interference fit engagement. A laminator adopting the lamination roller therefor comprises a pair of lamination roller, a heating member, and a transmission mechanism. Configurations of the lamination rollers are similar to those mentioned above. The lamination rollers are disposed in close proximity to each other, so as to define a nip portion for laminating papers. Each of the lamination rollers comprises a rolling support, a heat resistant layer covering the rolling support and a pair of connecting members. The rolling supports are in a tubular shape. The connecting members are attached to respective end portions of the rolling support. The heating member is disposed in close proximity to the heat resistant layer of the lamination roller. The transmission mechanism is engaged with the connecting members to drive the connecting members rotating thereof.

As will be realized, the invention is capable of other and different embodiments and its several details are capable of modifications in various respects, all without departing from the invention. Accordingly, the drawing and description are to be regarded as illustrative and not restrictive.

Other objects, advantages and novel features of the present invention will be drawn from the following detailed description of preferred embodiment of the present invention with the attached drawings. The accompanying drawings are included to provide a further understanding of the invention, and are incorporated in and constitute a part of this specification. The drawings illustrate embodiments of the invention and, together with the description, serve to explain the principles of the invention, in which:

### BRIEF DESCRIPTION OF THE DRAWINGS

FIG. 1 is a cross section view of a conventional roller for laminating;

FIG. 2 is a cross section view of a roller for laminating in accordance with a preferred embodiment of the present invention; and

FIG. 3 is a cross section view of the roller of FIG. 2, together with a heating member.

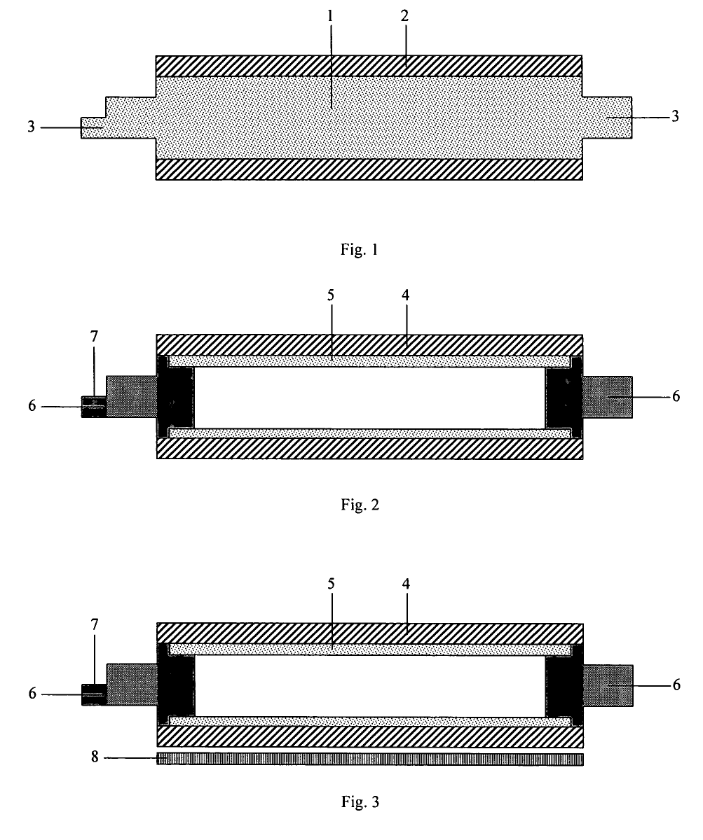

### DETAILED DESCRIPTION OF CERTAIN EMBODIMENTS

Throughout the drawings, the same reference numerals and characters, unless otherwise stated, are used to denote like features, elements, components or portions of the illustrated embodiments. Moreover, while the subject invention will now be described in detail with reference to the drawings, it is done so in connection with the illustrative embodiments. It is intended that changes and modifications can be made to the described embodiments without departing from the true scope and spirit of the subject invention as defined by the appended claims.

Referring from FIG. 2 to FIG. 3, the present embodiment relates to a roller for laminating purpose with improved configurations and a laminator adopting the roller therefor.

As embodied and broadly described herein, The roller of the present invention in accordance with the preferred embodiment, comprises a heat resistant layer 4, a rolling support 5 and a pair of connecting members 6 respectively disposed on distal ends of the rolling support 5. The heat resistant layer 4 is resilient and deformable so as to form a nip portion between the contiguous upper and lower lamination rollers to laminate cards and papers, covering surface of the rolling support 5. The heat resistant layer 4 can be made from a thermally conductive material, from one or a combination of materials, including but not limited to a low durometer rubber, a compressible rubber, a solid rubber silicone, a foam silicone rubber or others materials having similar deformable characteristics, such as urethane. The rolling support 5 is in a tubular configuration. The connecting member 6 connects the rolling support 5 with a transmission mechanism carrying rolling power of a laminator. One end portion of the connecting member 6 is cylindrical and diameter of end portion is slight longer than that inner diameter of the tubular rolling support 5, so that the end portion of the connecting member 6 can be fitted into the rolling support 5 in an interference fit engagement. The connecting member 6 engages with the transmission mechanism by a protuberant finger 7 with a planar fitting surface (not shown).

The engagement between the connecting member 6 and the rolling support 5 can be one of various connecting manners besides the interference fit engagement supra mentioned. The connecting member 6 can connect the rolling support 5 at one end portion by means of clipping, welding, attaching and so on. The tubular rolling support 5 can be made of materials such as hard gum, aluminum tube etc., with predetermined heat resistance and appropriate rigidity properties.

As again embodied and broadly described herein, the laminator of the present invention in accordance with the alternative embodiment, comprises 1 amination rollers, a heating member 8 and a power transmission mechanism (not shown). The heating member 8 can be a heating plate.

In the alternative embodiment of the present invention on the laminator adopting the lamination roller configured in the preferred embodiment, two lamination rollers are involved, an upper one and a lower one. Pressure is applied to upper lamination roller and lower lamination roller in a known manner by, for example, eccentric rollers, pressure levers, or other means that are not shown. A nip portion is defined between the upper lamination roller and the lower lamination roller. The lead edge of a card to be laminated is fed into the nip portion formed by moving upper lamination roller and lower lamination roller. As the card passes nip portion, heat resistant layers 4 over the rolling supports 5 of the lamination roller deform to increase the width of nip portion to form an enlarged nip width for nip portion. Nip portion is substantially uniform as it extends along the rotational axis of lamination rollers. This configuration eliminates or minimizes lateral shear stresses and overdrive as the card passes the nip portion.

As mentioned in the preferred embodiment, in the alternative embodiment of the present invention, the engagement between the connecting member 6 and the rolling support 5 can be one of various connecting manners besides the interference fit engagement supra mentioned. The connecting member 6 can connect the rolling support 5 at one end portion by means of clipping, welding, attaching and so on. The tubular rolling support 5 can be made of materials such as hard gum, aluminum tube etc., with predetermined heat resistance and appropriate rigidity properties.

The related embodiments supra described of the present invention adopt disjunctive roller configuration. The lamination rollers are divided into different subsections made of different materials according to different individual functions, so as to achieve minimum material waste and cost saving purpose. The lamination roller is configured in tubular shape, which reduces gross weight of the roller, and thereby lowing power consumption of the laminator. The connecting member 6 engages with the rolling support 5 in an interference fit engagement and other engagement alike with simplified structure, so that the connecting member 6 can be easily detached from the rolling support 5.

Having thus described particular embodiment of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A lamination roller comprising:
a rolling support, the rolling support in tubular shape covered by a heat resistant layer; and
a pair of connecting members, the connecting members respectively attached to end portions of the rolling support, the connecting member driven by a transmission mechanism.

2. The lamination roller as claimed in claim 1, wherein one portion of the connecting member joining the rolling support is cylindrical, the diameter of the cylindric portion of the connecting member is slightly longer than inner diameter of the tubular rolling support, thereby the connecting member can be fitted into the tubular rolling support in an interference fit engagement.

3. A laminator comprising:
a pair of lamination roller, disposed in close proximity to each other, so as to define a nip portion for laminating papers, each of the lamination roller comprising a rolling support, a heat resistant layer covering the rolling support and a pair of connecting members, the rolling supports being in a tubular shape, the connecting members attached to respective end portions of the rolling support; and
a heating member, disposed in close proximity to the heat resistant layer of the lamination roller; and
a transmission mechanism, engaged with the connecting members to drive the connecting members rotating thereof.

4. The laminator as claimed in claim 3, wherein one portion of the connecting member joining the rolling support is cylindric, the diameter of the cylindrical portion of the connecting member is slightly longer than inner diameter of the tubular rolling support, thereby the connecting member can be fitted into the tubular rolling support in an interference fit engagement.
